(19) United States
(12) Patent Application Publication
(10) Pub. No.: US 2014/0251918 A1
(43) Pub. Date: Sep. 11, 2014

(54) Dissolvable Bed Chromatographic Column and Methods of Use

(71) Applicants: Matthias Rainer, Innsbruck (AT); Lee Hoang, Santa Clara, CA (US); Douglas T. Gjerde, Saratoga, CA (US); Guenther Bonn, Zirl (AT)

(72) Inventors: Matthias Rainer, Innsbruck (AT); Lee Hoang, Santa Clara, CA (US); Douglas T. Gjerde, Saratoga, CA (US); Guenther Bonn, Zirl (AT)

(21) Appl. No.: 14/203,365

(22) Filed: Mar. 10, 2014

Related U.S. Application Data
(60) Provisional application No. 61/774,970, filed on Mar. 8, 2013.

(51) Int. Cl. G01N 1/34

(52) U.S. Cl. CPC G01N 1/34
USPC 210/702; 422/514

(57) ABSTRACT

An automated or semi-automated method was developed for the isolation of proteins using lanthanide metals. Phosphoproteins and glycoproteins can be isolated from complex biological samples using filtration with novel column configurations.

### CROSS REFERENCE TO RELATED APPLICATIONS

This patent application claims the benefit of U.S. Provisional Application No. 61/774,970, filed Mar. 8, 2013, which is incorporated by reference herein.

### FIELD OF THE INVENTION

This invention relates to devices and methods for the isolation of phosphoproteins and glycoproteins and their fragments. Proteins are isolated from biological samples using lanthanide metals.

### BACKGROUND OF THE INVENTION

Manual methods for the isolation of phosphoproteins and glycoproteins from a biological sample were described previously (see U.S. patent application Ser. No. 13/270,148, Güzel et al., Anal Bioanal Chem (2012) 403:1323-1331 and Pink et al., J. Proteomics, 75 (2011) 375-383). In these methods, centrifugation was used to isolate phosphoproteins and glycoproteins from a biological sample. The sample was mixed with a lanthanide metal ion and centrifugation was used to bring the protein precipitate into a pellet. Centrifugation is a viable method to concentrate the particles into a pellet because the forces are high and can handle very small particles and a range of particle sizes without prior knowledge of the particle size and particle size range. Centrifugation works well because a strong centrifugal force can be used to form a pellet at bottom of a centrifuge tube. Micron-sized particles and even nanoparticles can be brought into the pellet. Washing or chemical reaction of a precipitate has been performed by resuspending the pellet in the solution, dispersing the solid as a suspension, and then reforming the pellet by centrifugation.

However, many things remain unknown about this process. The physical nature of phosphoprotein and glycoprotein metal ion precipitates, how they are formed and why they are formed is unknown and unpredictable. No studies have been done on the size of particle formed with lanthanide protein precipitates and it is unknown what size particles are formed under which conditions. It is unknown if the size of the particle can be controlled or if a range of particles sizes are formed. It is unknown if the size of the particles are nanoparticle size or micron particle size or both. Even with variable particle sizes, different samples and other unknown variables, centrifugation is a successful method for forming a metal phosphoprotein pellet. The success of this method is surprising because the way in which a lanthanide metal phosphoprotein or glycoprotein precipitate forms is not understood.

In the present invention, the method has been significantly modified and improved so that it is amenable to automation. Filtration is used as an alternative method to centrifugation and the methods can be performed using a pipette tip fitted with a frit or filter screen. Since the centrifugation steps were eliminated, the method can be performed in an automated, high-throughput fashion.

Prior to the development of this method, it was not known whether filtration could be used to capture phospho- or glycoproteins in a precipitate and then process the precipitate to isolate the target proteins. The use of filtration to form a lanthanide phosphoprotein and/or glycoprotein precipitate was even more unexpected and unpredictable than the use of centrifugation. In most methods, it is necessary to know the particle size and particle size range for filtration to be successful. However, this information was not known for a lanthanide protein precipitate. There is no information available on the particle size range of the material formed, or how the size of the precipitate might change with various samples, different lanthanide metals or varied environmental conditions.

The use of filtration during the washing process was even more unpredictable. The effects of the washing solvent on the lanthanide protein precipitate particle size and particle size range was unknown and could not be predicted. In the washing process, the filtrate is brought into contact with a solution to remove nonspecifically-bound materials. It was not known whether the wash solution would simply pass over the precipitate or whether the precipitate would go into solution partially or completely when it was brought into contact with a washing liquid. Finally, it was unknown whether the lanthanide protein precipitate could be re-dissolved and proteins recovered using a filtration format.

### BRIEF DESCRIPTION OF THE FIGURES

FIG. 1 is a depiction of an unpacked column of the invention.

FIG. 2 is a depiction of a dissolvable packed bed column.

### DETAILED DESCRIPTION OF THE INVENTION

A process was developed by which phosphoproteins and glycoproteins can be isolated from a complex biological sample using a pipette tip with a frit or filter screen positioned at the lower end of the tip. Lanthanide metals are used to isolate phosphoproteins using filtration in an automated or semi-automated process. The general steps of the process are listed below.
1. Provide the sample and lanthanide metal ion
2. Form a precipitate
3. Filter
4. Wash the precipitate, perhaps multiple times
5. Filter
6. Dissolve the precipitate
7. Recover the filtrate
8. Perform downstream analysis

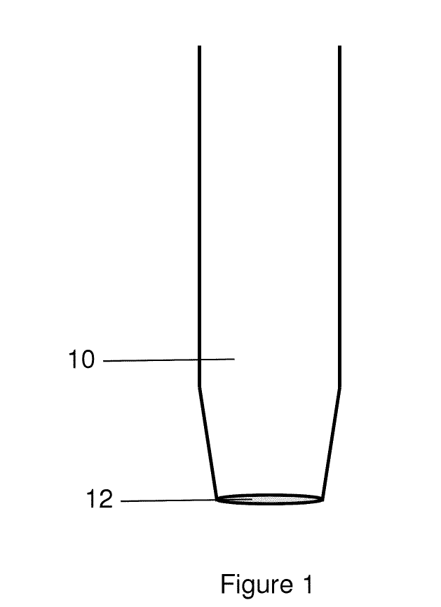

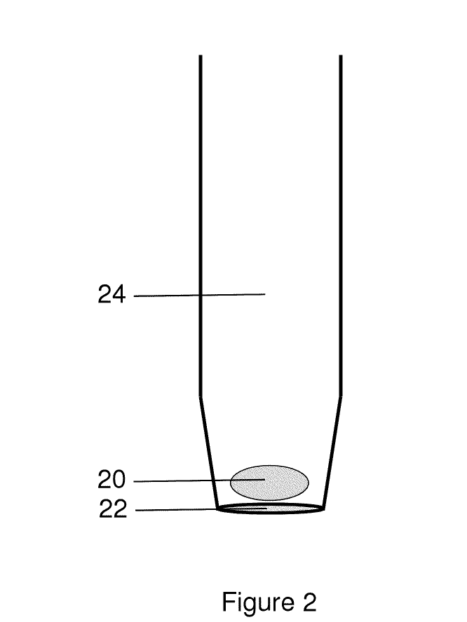

The filtration process is performed in a column, such as those depicted in FIGS. 1 and 2. In some embodiments, the column is a pipette tip column. A “pipette tip column” is defined herein as a column adapted to engage a pipette or liquid handler. The column depicted in FIG. 1 is an unpacked column and possesses column chamber 10 and frit or filter screen 12. Filter screen 12 is unlike filters found on commercially-available pipette filter tips in that the pore size of the screen is relatively large, e.g., greater than 5 microns. Because of the large pore size, the tip possesses very low backpressure which allows the use of a low pressure pump, such as a pipette or syringe pump. Smaller pore size filters are also possible, perhaps down to 1 micron, however greater pumping or filtering pressure would probably need to be used.

It should be noted that the dissolvable bed column can also exploit other chemistries. For example, a barium chloride or barium nitrate salt can be used as the column packing material. A liquid sample can be drawn up into the bed dissolving the packing material. In cases where the sample contains a soluble sulfide or sulfide containing compound, a precipitate will form. The precipitate can be washed several times. After washing the barium sulfide can be dissolved and eluted with an acid such as hydrochloric acid.

The process begins by providing a denatured or raw sample containing unknown proteins to the top of an unpacked column. The sample can be denatured however, it is not mandatory. The sample may be any liquid. In certain embodiments, the sample is a biological material referred to herein as a biological sample. Non-limiting examples of sample types include tissues, body fluids such as serum, cerebrospinal fluid or urine, cell cultures, HeLa cells, cell lysates, cell-free cultures, yeast, bacteria or food samples. Biological samples can be obtained from any organism.

The sample is mixed with a lanthanide metal ion and a precipitate is formed between the lanthanide and the phosphoproteins and/or glycoproteins within the sample. The terms, “lanthanides”, “lanthanide metals”, “lanthanide metal ions”, lanthanide salt and “lanthanoids” are used herein as equivalents and refer to the chemical elements with atomic numbers 57 through 71. In some embodiments, the precipitate can be formed within the chamber of an unpacked or empty column, a column that contains no packing but possesses a bottom frit or screen. In these embodiments, the column can be a pipette tip column such as the unpacked column depicted in FIG. 1. In other embodiments, the precipitate can be formed outside the column chamber and then introduced into the chamber.

In certain embodiments, the lanthanide can be present in the column prior to addition of the sample. When the lanthanide salt is packed as a solid into a column, the column can be referred to as a dissolvable packed bed column (FIG. 2). The lanthanide material is a dissolvable packing material because as soon as it comes in contact with a liquid sample, the packing material dissolves. After contact with the sample, a precipitate is formed that contains the target material of interest, e.g., a lanthanide-protein precipitate. This precipitate can then be treated as any material in a column would be treated. That is, it can be washed, treated with enzyme, and other reactants, denatured, etc.

The dissolvable packed bed columns can be prepared in a number of ways. One way is to simply add the solid packing material into the column from the top. The solid packing material is retained by the bottom frit in the column. In another embodiment, the salt may be added as a solution to the column chamber above the bottom frit. The liquid is evaporated and the solid packing material remains.

The dissolvable packed bed columns may be stored for months and even years before use or may be stored on a robotic system awaiting introduction of a sample.

A typical dissolvable packed bed column is depicted in FIG. 2. Dissolvable packing material 20 may be added to pipette tip column 24. In other embodiments, the dissolvable packing material can be added to 96-well plate columns or any type of column in which the material may be retained and dissolved when used.

In some embodiments, the filters may be configured into a plate, such as a 96-well plate. In these embodiments, vacuum, pumping, positive pressure, gravity or any suitable force may be used to separate the precipitate from the liquid.

The packing material is dissolved upon contact with the sample or with the solution used to prepare the column for sample introduction. This may be accomplished by adding liquid to the top of the column into the column bed. Alternatively, this may be accomplished by drawing liquid up into the column bed through the bottom frit of the column. For example, in one embodiment, the sample containing phosphoproteins is added to the top of the column. In some embodiments, a co-precipitant, such as phosphate can be added to increase the mass of the precipitate. The lanthanide salt column packing material dissolves in the presence of the liquid. The liquid may be mixed by inserting a pipette tip into the top of the column. After some time, a phosphoprotein and phosphate precipitate is formed with the lanthanide metal.

In some embodiments, the sample is added to the dissolvable packed bed column without a co-precipitate forming material. A lanthanide precipitate is formed with the phosphoproteins or glycoproteins. In these embodiments, co-precipitate forming phosphate may be added after the sample is added.

For example, the sample can be introduced to the dissolvable packed bed column by drawing the sample up through bottom frit 22 (FIG. 2). The sample dissolves solid packing 20 as it passes through the dissolvable bed. The sample remains in the column while the packing dissolves. Alternatively, the sample may be drawn back and forth in and out of the column. However, if back and forth flow is used, it must be done in such a way that the precipitate formed is inside column 24. The back and forth flow is often done in a timely manner because once the precipitate is formed, the precipitate is retained by frit 22. The precipitate may grow larger as a function of time.

In most cases, it is desirable to have the precipitate retained in the column. In alternate embodiments, the precipitate may be retained in the well of a plate.

In still other embodiments, the precipitate formation within the body can be enhanced by mixing the reagents within the column chamber. Mixing can be accomplished by pulling air through the bottom frit and through the liquid, or may be accomplished by inserting a pipette tip into the top of the column and mixing the liquid with (repeated) aspiration and expulsion of the precipitate-forming mixture.

In still other embodiments, the precipitate can be formed outside the column and then transferred into the column chamber for the washing and recovery steps.

After formation of the precipitate, any liquid remaining the column is removed. In the case of an unpacked pipette tip column, liquid can be removed by attachment of the column to a pipette or liquid handler and pushing air through the column. If the columns are integrated into a microplate, such as a 96-well plate, vacuum can be used to draw air through the columns to remove any remaining liquid.

The next step involves washing the precipitate. After the precipitate is formed, the precipitate and pellet formed from the precipitate will stay in the column as wash liquids are passed through frit. Wash liquids can be added to the precipitate inside the column chamber and filtration can be used to remove the liquid from the column.

In some embodiments, the wash liquid is introduced through the lower end of the column while in other embodiments, the wash liquid may be introduced into the top of the column with a pipette tip or other means. The precipitate may be washed using back and forth flow by drawing the wash liquid up through the bottom of the column and then expelling the liquid back through the column bottom. Alternatively, wash solutions may be added to the top of the column and passed over the precipitate using unidirectional flow.

The wash can be repeated several times. Repeated washes can be performed with the same wash solvent or with a variety of wash solvents.

Diverse wash solvents can be used as long as the metal phosphoprotein remains intact. Wash solvents can be comprised of organic solvents, acids, bases and buffers and aqueous acids bases or buffers. For example, a 200 μL DHB solution (110 mM in 0.5% ACN/0.5% TFA) can be used for the wash step(s).

In some embodiments, the wash solution may break up the precipitate partially or completely, while in other embodiments, the wash solution may just pass over the precipitate.

Finally, a dissolving liquid such as an acid is introduced to the column and mixed to dissolve the solid. In some embodiments, the dissolving liquid is introduced into the top of the column, while in other embodiments, the dissolving liquid is introduced from the bottom of the column and aspirated into the column bed to dissolve the precipitate. The liquid may be repeatedly drawn in and expelled to completely dissolve the pellet. The liquid containing the phosphoproteins and/or glycoproteins is pushed through the column with a pipette or robotic head and the sample is recovered in the well of a deep-well plate positioned below.

In alternate embodiments, the precipitate is not dissolved but instead, on-pellet enzyme digestion (e.g. trypsin) is performed.

The columns and methods of the invention may be used in a semi-automated or automated fashion. The use of filtration allows automated parallel processing of multiple samples. The term “automated” is defined as a process by which sample processing is performed by a robotic system controlled by a timed computer program. The method can be performed in a walk-away manner without operator intervention. In some embodiments, the method is performed in a semi-automated fashion. The term “semi-automated” is defined as a process by which two or more samples, columns or tubes are processed simultaneously. It is surprising and unexpected that an automated process can be used for this process because the methods can be performed without visual monitoring of the columns.

Downstream analysis can be performed on the purified proteins. For example, a MALDI mass spectrometry analysis process may identify both known and unknown species. Alternatively, the samples may be separated by slab gel electrophoresis and individual proteins can be analyzed by MALDI and/or LC-MS for top down or bottom up analysis. IR and NMR or other analytical tools may be used to identify the number and location of chemical groups on proteins. Other techniques including HPLC may be used to separate the proteins.

The invention is additionally drawn to a kit comprised of reagents for performing the methods of the invention.

Having now generally described the invention, the same will be more readily understood through reference to the following examples, which are provided by way of illustration, and are not intended to be limiting of the present invention, unless so specified.

### EXAMPLES

### Example 1

### Method for Using Unpacked Pipette Tip Columns with Electronic, Programmable Pipettes

1. Unpacked pipette tip columns are positioned (in row 1) in plate cover over 500 μL deep well plate
2. Provide sample (50 μL) to row of unpacked pipette tip columns

Use pipette in pipette stand to place the sample inside the columns

3. Add precipitant metal ion solution (5 μL) and mix

Use pipette in pipette stand to mix

4. Add phosphate solution and mix (5 μL) and mix (steps 2 and 3 may be reversed)

Use pipette in pipette stand to mix

5. Blow out liquid through bottom of column and form pellet

Place pipette in unpacked pipette tip column and activate blow out

6. Add wash 1 (50 μL), mix and blow out liquid to form pellet (repeat two times)

Use pipette stand to add liquid and mix, place pipette in unpacked pipette tip columns to blow out liquid

7. Add wash 2 (50 μL), mix and blow out liquid to form pellet (repeat two times)

Use pipette stand to add liquid and mix, place pipette in unpacked pipette tip columns to blow out liquid

8. Add wash 3 (50 μL), mix and blow out liquid to form pellet (repeat one time)

Use pipette stand to add liquid and mix, place pipette in unpacked pipette tip columns to blow out liquid

9. Place unpacked pipette tip columns in next row over to prepare for collection of sample in plate
10. Add dissolving agent (30 μL), mix to dissolve

Use pipette in pipette stand to mix

11. Blow out liquid of unpacked pipette tip columns to collect purified phosphoproteins

Place pipette in unpacked pipette columns over collection wells and activate blow out

### Example 2

### Preparation of Purified Proteins for MALDI Analysis

1. Deposit 5 μL of sample into 30 μL of matrix solution containing 20 mg/mL sinapinic acid in 50% acetonitrile and 0.1% trifluoroacetic acid (and 100 fmol/μL cytochrome C and angiotensin I for internal calibration) and mix.
2. From 1 above, 2 μL volume of prepared sample is taken up and deposited on at the appropriate position on the MALDI target. Typically 4 MALDI target spots are produced per MALDI column. After the column slurries have been prepared and spotted, the spots are air-dried and the MALDI plate is analyzed.

### Example 3

### Lanthanide Precipitation Using the PhyNexus MEA Instrument (PhyNexus, Inc., San Jose, Calif.) with Unpacked Pipette Tip Columns

### 1. Home

2. Provide 50 μL sample at position 8 (chiller—small well plate)—row 1
3. Take transfer tips (from position 1—row 1)
4. Take 50 μL sample and transfer to position 7 (row 1) into unpacked columns which are placed on a column holder
5. Release transfer tips at position 1—row 1
6. Take transfer tips (from position 1—row 2)
7. Add 5 μL precipitant solution (small well plate position 4—row 1) to sample at position 7—row 1
8. Cycle up and down (mixing)
9. Release transfer tips at position 1—row 2
10. Take transfer tips (from position 1—row 3)
11. Add 5 μL of phosphate solution (position 4—row 2) to sample at position 7—row 1
12. Cycle up and down (mixing)—pellet is formed
13. Release transfer tips at position 1—row 3
14. Aspirate 50 μL volume
15. Go to position 8—row 1 and load pipette tip columns—blowout 50 μL of aspirated volume to retrieve pellet (pellet should be dry and without liquids)—maybe rotate to remove drop on pipette tip column.
16. Release pipette tip columns at position 8—row 1
17. Take transfer tips (from position 1—row 4)
18. Move to position 6 (row 1) and take 50 μL of washing solution 1 and add into pipette tip columns at position 8—row 1
19. Cycle up and down for washing
20. Release pipette tip columns at position 1—row 4
21. Aspirate 50 μL volume
22. Go to position 8—row 1 and load pipette tip columns—blowout 50 μL of aspirated volume to retrieve pellet (pellet should be dry and without liquids)
23. Take transfer tips (from position 1—row 5)
24. Move to position 6 (row 1) and take again 50 μL of washing solution 1 and add into pipette tip columns at position 8—row 1
25. Cycle up and down for washing
26. Release pipette tip columns at position 1—row 5
27. Aspirate 50 μL volume
28. Go to position 8—row 1 and load pipette tip columns—blowout 50 μL of aspirated volume to retrieve pellet (pellet should be dry and without liquids)
29. Take transfer tips (from position 1—row 6)
30. Move to position 6 (row 1) and take again 50 μL of washing solution 1 and add into pipette tip columns at position 8—row 1
31. Cycle up and down for washing
32. Release pipette tip columns at position 1—row 6
33. Aspirate 50 μL volume
34. Go to position 8—row 1 and load pipette tip columns—blowout 50 μL of aspirated volume to retrieve pellet (pellet should be dry and without liquids)
35. Take transfer tips (from position 2—row 1)
36. Move to position 6 (row 4) and take 50 μL of washing solution 2 and add into pipette tip columns at position 8—row 1
37. Cycle up and down for washing
38. Release pipette tip columns at position 2—row 1
39. Aspirate 50 μL volume
40. Go to position 8—row 1 and load pipette tip columns—blowout 50 μL of aspirated volume to retrieve pellet (pellet should be dry and without liquids)
41. Take transfer tips (from position 2—row 2)
42. Move to position 6 (row 4) and take again 50 μL of washing solution 2 and add into pipette tip columns at position 8—row 1
43. Cycle up and down for washing
44. Release pipette tip columns at position 2—row 2
45. Aspirate 50 μL volume
46. Go to position 8—row 1 and load pipette tip columns—blowout 50 μL of aspirated volume to retrieve pellet (pellet should be dry and without liquids)
47. Take transfer tips (from position 2—row 3)
48. Move to position 6 (row 4) and take 50 μL of washing solution 2 and add into pipette tip columns at position 8—row 1
49. Cycle up and down for washing
50. Release pipette tip columns at position 2—row 3
51. Aspirate 50 μL volume
52. Go to position 8—row 1 and load pipette tip columns—blowout 50 μL of aspirated volume to retrieve pellet (pellet should be dry and without liquids)
53. Take transfer tips (from position 2—row 4)
54. Move to position 6 (row 6) and take 50 μL of washing solution 3 and add into pipette tip columns at position 8—row 1
55. Cycle up and down for washing
56. Release pipette tip columns at position 2—row 4
57. Aspirate 50 μL volume
58. Go to position 8—row 1 and load unpacked pipette tip columns—blowout 50 μL of aspirated volume to retrieve pellet (pellet should be dry and without liquids)
59. Take transfer tips (from position 2—row 5)
60. Move to position 6 (row 4) and take again 50 μL of washing solution 3 and add into pipette tip columns at position 8—row 1
61. Cycle up and down for washing
62. Release pipette tip columns at position 2—row 5
63. Aspirate 50 μL volume
64. Go to position 8—row 1 and load pipette tip columns—blowout 50 μL of aspirated volume to retrieve pellet (pellet should be dry and without liquids)
65. Take transfer tips (from position 2—row 6)
66. Move to position 4 (row 3) and take 30 μL of dissolving agent and add into pipette tip columns at position 8—row 1
67. Cycle up and down for washing (until unless the pellet is dissolved)
68. Take up the 30 μL dissolved pellet and place into a small well plate at position 3—row 1
69. Release pipette tip columns at position 2—row 6

### 70. Home

### Example 4

### Preparation of Dissolvable Packed Bed Columns

1 M solution of erbium chloride was prepared and added to the top of a frit of columns having 6, 10, 15 and 21 μm frit pores. In this example, 1.5 μL, 3 μL and 4.5 μL were added to the top of the frit of each column type forming a liquid drops on top of the frit containing 1.5, 3 and 4.5 mmoles, respectively. The drop is small and remains substantially on top of the frit. The columns were placed in an oven at 80° C. for 20 minutes and the erbium chloride drops dried, leaving the solid dissolvable packing material in the column. The columns containing the dissolvable packing material were still stable days and weeks later.

### Example 5

### Preparation and Use of Dissolvable Packed Bed Columns

The dissolved packed bed column is prepared with a 11 μm pore size screen frit column. The packing material is formed with 3 mmoles of lanthanum chloride crystal packing material on top of the frit. In one example, 50 μL of a sample containing phosphoproteins are added to a dissolvable packed bed column. 20 μL of 0.5 M KH₂PO₄ is added to the solution above the frit and the solution is mixed with a transfer tip until the precipitate crystals are formed.

### Example 6

### Use of a Co-Precipitant

This method used in this example is the same as that used in Example 5 except that the phosphate co-precipitant is mixed with the sample before the sample is dispensed into the dissolvable packed bed column. 2 μL of 2 M KH₂PO₄ is added to a sample and the mixture added to the dissolvable packed column.

### Example 7

### Reagents and Solutions which Could Be Used in a Kit

This kit includes for protein denaturation of the sample. Surprisingly this denaturation step may influence phosphoprotein precipitation and may determine which phosphoproteins are captured and their amounts.

The sample preparation includes before precipitation:
50 μL protein samples (1 mg/ml)
5 μL of 40 mM nOGP

### 5 μL of 45 mM DTT or TCEP

### Example 8

### Method for Using Dissolvable Packed Bed Columns

After protein denaturation add denatured sample (60 μL) to the dissolved packed bed pipette tip columns. After the packing has dissolved, the phosphoprotein precipitate is form. Next, 25 μL of 50 mM KH₂PO₄ is added to the liquid as a co-precipitant. The precipitate is formed with additional time. At this point the particles are large enough so that when the liquid is pushed through the frit with pressure and the pellet is formed after the liquid is expelled.

The washing of the precipitate is performed with 200 μL 80 mM of the respective lanthanide chloride (the same lanthanide is used to was as was used to form the initial precipitate) solution two times, then with 200 μL DNB solution (110 mM in 0.5% ACN/0.5% TFA. Finally one or more washing steps with 200 μL of deionized H₂O is performed. Finally, the pellet is dissolved with 30 μL of 30% formic acid. The pellet may be dissolved by introducing the acid at the bottom of the column or the top. The dissolved liquid is deposited in a well and then analyzed.

### Example 9

### Use of a Salt Wash

The method is the same as that in Example 8 except a metal phosphate precipitate-forming salt is used to wash the precipitate or pellet.

### Example 10

### Use of Different Wash Solvents

The method is the same as that in Example 8 except calcium chloride, barium chloride or a rare earth metal salt is used to wash the precipitate.

### Example 11

### Methods, Reagents, Volumes and Concentration Used to Form and Process 96 Dissolvable Packed Bed Columns

45 mM DTT (dithiothreitol), 0.48 mL
40 mM nOGP n-Octyl-b-D-glucopyranoside, 0.48 mL

### 50 mM KH₂PO₄, 2.4 mL

110 mM DHB 2,5-dihydroxybenzoic acid in ACN acetonitrile and TFA trifluoroacetic acid, 38.4 mL

### H₂O, 19.2 mL

30% formic acid, 2.88 mL

The dissolvable packed bed columns are prepared with 0.24 mL of a 2 M lanthanide metal ion chloride for 96 columns.

The sample can be treated with DTT to reduce the disulfide bonds of proteins and to break intramolecular and intermolecular disulfide bonds between cysteine residues of proteins. However, DTT cannot break buried (solvent-inaccessible) disulfide bonds, so reduction of disulfide bonds can be carried out under denaturing conditions at high temperatures or in the presence of a denaturant such as 6 M guanidinium hydrochloride, 8 M urea, or 1% sodium dodecyl sulfate or other surfactants such as nOGP n-Octyl-b-D-glucopyranoside, a nonionic surfactant.

Due to air oxidation, DTT is a relatively unstable compound and should be stored by refrigeration and handling in an inert atmosphere. DTT becomes less potent as the pH lowers. (2S)-2-amino-1,4-dimercaptobutane (dithiobutylamine or DTBA) is a dithiol reducing agent that somewhat overcomes this limitation of DTT. Tris(2-carboxyethyl)phosphine HCl (TCEP hydrochloride) is an alternative reducing agent that is more stable and works even at low pH.

It should be noted that washing with lanthanide chloride solution may remove materials precipitated by mechanisms other than phosphate precipitation. For example, if glycoproteins are co-precipitated in the initial step, then washing with a lanthanide will remove these materials since the glycol interaction may be in equilibrium. Other metal salts may be used for washing including calcium and barium.

### Example 12

### Method for Using Dissolvable Packed Bed Pipette Tip Columns

The pipette used to force liquid through the column may be semiautomatic, electronic and programmable. In some embodiments, vacuum or pressure can be used to force liquid through the columns.

1. Dissolvable packed bed columns with lanthanide solid packing material are positioned (in row 1) in plate cover over 500 μL deep well plate
2. Option 1. Provide sample (50 μL) to row of wells in the plate. Sample is drawn rapidly into the column dissolving the lanthanide into solution. The solution may be expelled and aspirated one or more times while the precipitate particles are small and move through the frit.
2. Option 2. Provide sample (50 μL) to the column chamber (reference no. 22 in FIG. 2). Sample dissolves lanthanide salt or is expelled and aspirated rapidly into the column dissolving the lanthanide into solution. The solution may be expelled and aspirated one or more times while the precipitate particles are small enough to move through the frit.
3. Option 1. Phosphate co-precipitant solution may be added to the sample in well. Sample plus co-precipitant is drawn rapidly into the column dissolving the lanthanide into solution. The solution may be expelled and aspirated one or more times while the precipitate particles are small and move through the frit.
3. Option 2. Phosphate co-precipitant solution may be added to the sample in column chamber. Sample plus co-precipitant may be mixed in column chamber to dissolve lanthanide and form precipitate. The solution may be expelled and aspirated one or more times while the precipitate particles are small and move through the frit.
4. Blow out liquid through bottom of column. A precipitate will remain in the column.
5. Add wash 1 (50 μL), mix and blow out liquid to form pellet, wash solution can be added above pellet and liquid blown out through pellet.(optional repeat two times)
6. Optional Add wash 2 (50 μL), mix and blow out liquid to form pellet, wash solution can be added above pellet and liquid blown out through pellet. (optional repeat two times)
7. Optional Add wash 3 etc. (50 μL), mix and blow out liquid to form pellet, wash solution can be added above pellet and liquid blown out through pellet. (optional repeat two times)
8. Place the dissolvable packed bed columns in a plate to prepare for collection.
9. Add a precipitate dissolving agent (30 μL) from the bottom or the top of column and mix to dissolve.
10. Blow out the liquid from the columns to collect purified phosphoproteins.

### Example 13

### An Automated Method

A similar process could be used where the z movement of the pipette and the x and y movement of the plate or robotic head can be completely automated.

What is claimed is:

1. A column, wherein the column is comprised of
a bottom frit;
a chamber; and
packing material inside the chamber, wherein the packing material dissolves when liquid is introduced into the column chamber.

2. The column of claim 1, wherein the column is a pipette tip column.

3. The column of claim 1, wherein the packing material comprises a lanthanide metal.

4. A method, comprising
providing the column of claim 1,
introducing a biological liquid sample, wherein the column packing material dissolves when liquid is introduced into the column.

5. The method of claim 4, wherein after the column packing material dissolves, a precipitate is formed.

6. The method of claim 5, wherein the packing material comprises a lanthanide metal and a precipitate is formed between the lanthanide metal and proteins in the biological sample.

7. The method of claim 6, wherein the proteins are phosphoproteins.

8. The method of claim 4, wherein the biological liquid sample enters the column from the top of the column.

9. The method of claim 4, wherein the biological liquid sample enters the column from the bottom of the column.
